(19) United States
(12) Patent Application Publication
(10) Pub. No.: US 2005/0197107 A1
(43) Pub. Date: Sep. 8, 2005

(54) Network support for mobile subscriber directory look-up

(75) Inventors: Peggy Hasan, Aurora, IL (US); Sandra Lynn True, St. Charles, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114-2518, US

(73) Assignee: Lucent Technologies Inc.

(21) Appl. No.: 10/793,159

(22) Filed: Mar. 4, 2004

(51) Int. Cl. H04M 1/66; H04M 1/68; H04M 3/16; H04M 1/00; H04B 1/38

(52) U.S. Cl. 455/414.1; 455/564

(57) ABSTRACT

A method of providing an automated directory look-up service in a wireless telecommunications network includes: receiving a request from a mobile station (MS) (10) to use the automated directory look-up service; prompting a user to enter a query into the MS (10), the query including at least a partial portion of an entry for the party to be looked up; receiving the query from the MS (10) over the wireless network; searching a database (32) containing a list of parties along with their corresponding telephone numbers; finding those parties in the database (32) that match the query; and, returning to the MS (10) entries from the list that match the query.

### FIELD

The present inventive subject matter relates to the telecommunication arts. Particular application is found in conjunction with wireless mobile devices (e.g., mobile telephones and the like), and the specification makes particular reference thereto. However, it is to be appreciated that aspects of the present inventive subject matter are also amenable to other like applications.

### BACKGROUND

Unlike a landline telephone user that typically has ready access to a phonebook to look up the number of the individual or business or other party they wish to call, a mobile telephone user often does not have similar access insomuch as unwieldy phonebooks are not often kept on one's person. Accordingly, mobile telephones and/or wireless mobile devices are commonly provisioned with an internal electronic telephone directory or phonebook. Again, however, such internal electronic phonebooks are not entirely sufficient. For example, the mobile device's electronic phonebook typically is preprogrammed with only those numbers frequently called by the owner of the device. Accordingly, it cannot be used to find the phone number of an individual or business or other party not already entered in the device.

Consequently, there remains a desire to have a means for finding the telephone number of a party not already entered in the mobile device. One approach has been to employ an operator assisted directory look-up service. In this approach, the user calls a predetermined telephone number such as 411, and is connected with a live operator or directory assistance personnel. Typically, after asking the user for the location (e.g., what city) and name of the listing sought, the directory assistance operator finds the telephone number the user is looking for and optionally connects the call to that telephone number. This approach however is labor intensive and suffers the drawbacks typically accompanying a labor intensive solution. Moreover, the telephone number is typically not saved in what is known as the mobile device's “recent calls list” since the call is placed and/or connected by the operator rather than dialed with the mobile device itself. Additionally, as the telephone number is typically read to the user by the operator or a synthesized voice, the telephone number is not easily stored in the mobile device's electronic phonebook.

Accordingly, a new and improved automated directory look-up service for wireless mobile devices is disclosed that overcomes the above-referenced problems and others.

### SUMMARY

In accordance with one preferred embodiment, a method of providing an automated directory look-up service in a wireless telecommunications network includes: receiving a request from a mobile station (MS) to use the automated directory look-up service; prompting a user to enter a query into the MS, the query including at least a partial portion of an entry for the party to be looked up; receiving the query from the MS over the wireless network; searching a database containing a list of parties along with their corresponding telephone numbers; finding those parties in the database that match the query; and, returning to the MS entries from the list that match the query.

In accordance with another preferred embodiment, an automated directory look-up service is provided in a wireless telecommunications network. The automated directory look-up service includes: means for receiving a request from a MS to use the automated directory look-up service; means for prompting a user to enter a query into the MS, the query including at least a partial portion of an entry for the party to be looked up; means for receiving the query from the MS over the wireless network; means for searching a database containing a list of parties along with their corresponding telephone numbers; means for finding those parties in the database that match the query; and, means for returning to the MS entries from the list that match the query.

In accordance with yet another preferred embodiment, a wireless telecommunications network supporting an automated directory look-up service for mobile stations includes: a database in which is maintained a list of telephone service subscribers along with their corresponding telephone numbers; and, a mobile switching center (MSC) that has access to the database. The MSC receives a request from a mobile station (MS) to use the automated directory look-up service; transmits a message to the requesting MS prompting a user to enter a query into the MS, the query including at least a partial portion of an entry for the party to be looked up; receives the query from the MS; searches the database to find those parties in the database that match the query; and, returns to the MS entries from the database that match the query.

Numerous advantages and benefits of the inventive subject matter disclosed herein will become apparent to those of ordinary skill in the art upon reading and understanding the present specification.

### BRIEF DESCRIPTION OF THE DRAWINGS

The inventive subject matter may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1 is a diagrammatic illustration of a wireless telecommunications network suitable for practicing aspects of the present inventive subject matter.

FIG. 2 is a flow chart illustrating an exemplary process for an automated directory look-up service embodying aspects of the present inventive subject matter.

### DETAILED DESCRIPTION OF PREFERRED EMBODIMENTS

For clarity and simplicity, the present specification shall refer to structural and/or functional network elements, entities and/or facilities, relevant communications standards, protocols and/or services, and other components that are commonly known in the telecommunications art without further detailed explanation as to their configuration or operation except to the extent they have been modified or altered in accordance with and/or to accommodate the preferred embodiment(s) presented.

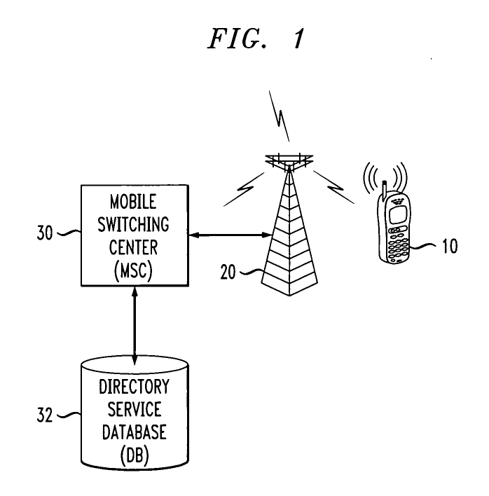

With reference to FIG. 1, a mobile device or MS 10 (e.g., a mobile telephone or other wireless mobile end user equipment) selectively connects with a wireless telecommunications network via a base station (BS) 20 served by a mobile switching center (MSC) 30. Suitably, the MS 10 is provisioned with the usual elements, e.g., a keypad with traditional numeric keys, soft keys, navigation keys, etc.; a liquid crystal display (LCD) or other such display; an electronic phonebook; and, other components commonly found on or incorporated in a MS.

The MSC 30 has access to a directory service database (DB) 32. Suitably, a list of mobile subscribers along with their corresponding telephone numbers is maintained in the DB 32. Optionally, in addition to or in lieu of mobile subscribers, the DB 32 optionally contains a listing along with corresponding telephone numbers for landline telephone subscribers. In any event, the MSC 30 is suitably programmed to administer an automated directory look-up service (ADLUS) to those mobile users subscribing to the ADLUS feature.

While only one MS and one BS are illustrate for purposes of simplifying the description herein, it is to be appreciated that a plurality of similarly situated elements are likely employed in the wireless network. That is to say, one MSC may optionally serve a plurality of BS and each BS may have a plurality of MS within their coverage area. Moreover, the wireless network optionally includes a plurality of similarly situated MSCs.

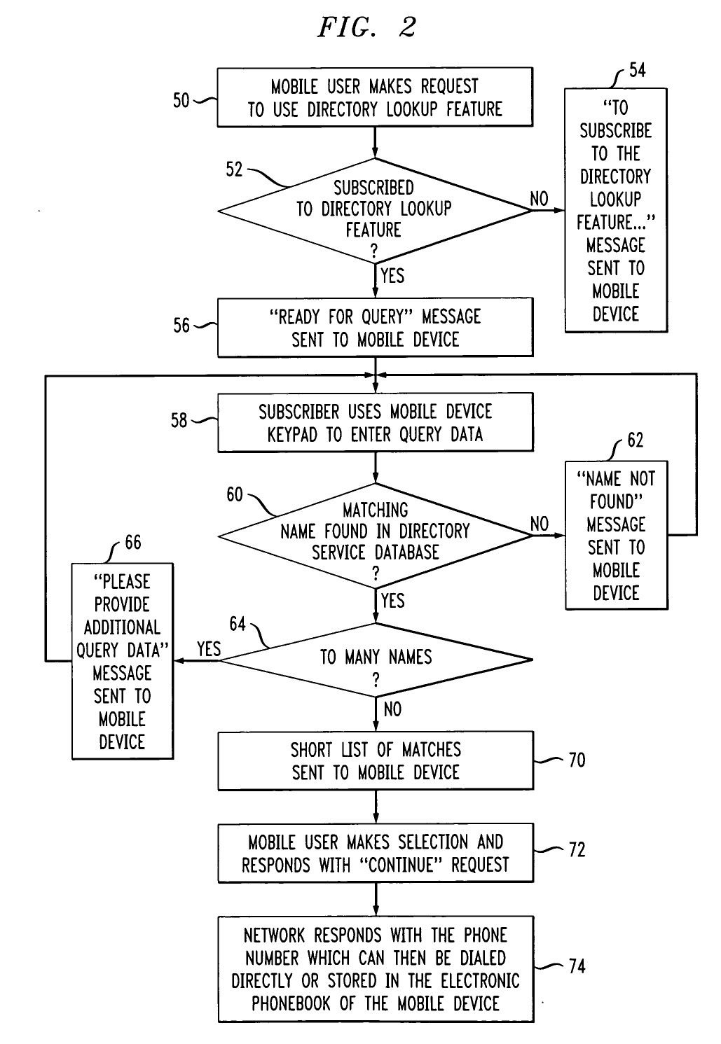

With reference to FIG. 2, at step 50, a mobile user makes a request to use the ADLUS feature. Suitably, the request is made by entering a designated key sequence or other input into the MS 10. The request is ultimately transmitted over the wireless network to the MSC 30 (i.e., from the MS 10 to the BS 20 and on to the MSC 30).

Optionally before proceeding further, at decision step 52, the MSC 30 first decides if the mobile user making the request subscribes to the ADLUS feature. If not, at step 54, a “service not available” message is returned over the wireless network from the MSC 30 to the MS 10. When received, the message is displayed on the MS 10 indicating that the ADLUS feature is not available under the user's current service plan, and optionally how the user can go about obtaining the proper subscription. Otherwise, if the user does subscribe to the ADLUS feature, then at step 56, a “ready for query” message is returned over the wireless network from the MSC 30 to the MS 10 prompting the user to enter a query.

At step 58, the user enters the query into their MS 10 using its keypad or other input device. Suitably, the query is a name or listing or a partial portion thereof corresponding to a mobile subscriber or other party the user is seeking. This information is in turn transmitted over the wireless network to the MSC 30. The MSC 30 uses the received query to access the DB 32. That is to say, the received query is checked against the listing of mobile subscribers maintained in the DB 32, i.e., the DB 32 is searched by the MSC 30 to find entries that match the query.

At decision step 60, it is determined if at least one name, listing or entry matching the received query is found in the DB 32. If not, at step 62, a “not found” message is returned over the wireless network from the MSC 30 to the MS 10. When received, the message is displayed on the MS 10 indicating that no such listing is available or exists, and optionally prompting the user to try again (i.e., returning to step 58). Otherwise, if there is at least one matching name, listing or entry found in the DB 32, then at step 64, the MSC 30 determines if there are potentially “too many” matches. That is to say, the received query (especially if only a partial entry) may potentially match a vast number of entries listed in the DB 32. The actual limit or threshold is optionally designated as any suitable value, e.g., approximately 10 to 15 matches. If the threshold is exceeded, then at step 66, a “provide addition query data” message is returned over the wireless network from the MSC 20 to the MS 10 indicating that additional information is being request to further narrow the search, and prompting the user for further input (i.e., retuning to step 58). Otherwise, if the threshold is not exceeded, then at step 70, a short list of the matching entries are obtained from the DB 32 by the MSC 32 and transmitted over the wireless network to the MS 10.

When received, the matching entries are displayed on the MS 10, and at step 72, the mobile user uses the MS 10 to select one of the received entries (presumably, the one of interest) and responds with a “continue” request, thereby transmitting the chosen selection back to the MSC 30 over the wireless network. At step 74, the MSC 30 receives the selected entry from the MS 10 and responds by returning the corresponding telephone number for that entry. That is to say, the MSC 30 obtains from the DB 32 the corresponding telephone number for the entry received from the MS 10, and then transmits the obtained telephone number back to the MS 10 over the wireless network. Suitably, once the telephone number has been returned to the MS 10, the user has the option of dialing the telephone number with the MS 10 and/or storing it in the electronic phonebook maintained on the MS 10.

It is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

1. In a wireless telecommunications network, a method of providing an automated directory look-up service, said method comprising:
(a) receiving a request from a mobile station (MS) to use the automated directory look-up service;
(b) prompting a user to enter a query into the MS, said query including at least a partial portion of an entry for the party to be looked up;
(c) receiving the query from the MS over the wireless network;
(d) searching a database containing a list of parties along with their corresponding telephone numbers;
(e) finding those parties in the database that match the query; and,
(f) returning to the MS entries from the list that match the query.

2. The method of claim 1, further comprising:
(g) receiving from the MS a selection of one of the entries returned in step (f); and,
(h) returning to the MS the telephone number from the database corresponding to the selected entry.

3. The method of claim 2, wherein the telephone number returned to the MS in step (h) is returned such that it may be dialed with the MS upon selection of such an option by a user of the MS.

4. The method of claim 2, wherein the telephone number returned to the MS in step (h) is returned such that it may be stored in an electronic phonebook maintained on the MS upon selection of such an option by a user of the MS.

5. The method of claim 1, further comprising:
prior to step (b), determining if the MS subscribes to the automated directory look-up service.

6. The method of claim 5, wherein steps (b) through (f) are performed if it is determined that the MS does subscribe to the automated directory look-up service, otherwise steps (b) through (f) are not performed.

7. The method of claim 1, wherein if the number of parties in the database matching the query exceeds a threshold value, then a message is returned to the MS prompting a user to enter additional query data to narrow the search.

8. In a wireless telecommunications network, an automated directory look-up service comprising:
means for receiving a request from a mobile station (MS) to use the automated directory look-up service;
means for prompting a user to enter a query into the MS, said query including at least a partial portion of an entry for the party to be looked up;
means for receiving the query from the MS over the wireless network;
means for searching a database containing a list of parties along with their corresponding telephone numbers;
means for finding those parties in the database that match the query; and,
means for returning to the MS entries from the list that match the query.

9. The automated directory look-up service of claim 1, further comprising:
means for receiving from the MS a selection of one of the entries returned; and,
means for returning to the MS the telephone number from the database corresponding to the selected entry.

10. The automated directory look-up service of claim 9, wherein the telephone number returned to the MS is returned such that it may be dialed with the MS upon selection of such an option by a user of the MS.

11. The automated directory look-up service of claim 9, wherein the telephone number returned to the MS is returned such that it may be stored in an electronic phonebook maintained on the MS upon selection of such an option by a user of the MS.

12. The automated directory look-up service of claim 8, further comprising:
means for determining if the MS subscribes to the automated directory look-up service.

13. The automated directory look-up service of claim 9, further comprising:
means for determining if the number of parties in the database matching the query exceeds a threshold value, wherein if the threshold value is exceeded, then a message is returned to the MS prompting a user to enter additional query data to narrow the search.

14. A wireless telecommunications network supporting an automated directory look-up service for mobile stations, said network comprising:
a database in which is maintained a list of telephone service subscribers along with their corresponding telephone numbers; and,
a mobile switching center (MSC) that has access to the database, wherein said MSC:
receives a request from a mobile station (MS) to use the automated directory look-up service;
transmits a message to the requesting MS prompting a user to enter a query into the MS, said query including at least a partial portion of an entry for the party to be looked up;
receives the query from the MS;
searches the database to find those parties in the database that match the query; and,
returns to the MS entries from the database that match the query.

15. The network of claim 14, further comprising:
a base station (BS) that is served by the MSC, said BS establishing a wireless air interface with the MS.

16. The network of claim 15, wherein said MSC further:
receives from the MS a selection of one of the entries returned; and,
returns to the MS the telephone number from the database corresponding to the selected entry.
